(19) United States
(12) Patent Application Publication
(10) Pub. No.: US 2024/0386915 A1
(43) Pub. Date: Nov. 21, 2024

(54) VIDEO GENERATION METHOD AND APPARATUS, ELECTRONIC DEVICE, AND READABLE STORAGE MEDIUM

(71) Applicant: Beijing Zitiao Network Technology Co., Ltd., Beijing (CN)

(72) Inventors: Binbin LI, Beijing (CN); Tianqi CHEN, Beijing (CN)

(21) Appl. No.: 18/570,429

(22) PCT Filed: Oct. 19, 2022
(86) PCT No.: PCT/CN2022/126054

§ 371 Date: Dec. 14, 2023

(30) Foreign Application Priority Data
Oct. 20, 2021 (CN) 202111222468.1

(51) Int. Cl. G11B 27/031; H04N 5/91

(52) U.S. Cl. CPC G11B 27/031; H04N 5/91

(57) ABSTRACT

The present disclosure relates to a video generation method and apparatus, an electronic device, and a readable storage medium. The method includes: obtaining a plurality of editing process images in an image editing process for an image to be processed, wherein the image editing process includes a plurality of image editing operations sequentially executed for the image to be processed, and the plurality of editing process images are images obtained by executing different target image editing operations among the image editing operations on the image to be processed in the image editing process, respectively; and generating a recorded video of the image editing process on the basis of the editing process images, wherein video frame images in the recorded video comprise editing process images, and the time sequence of the editing process images in the recorded video corresponds to the editing sequence in the image editing process.

### CROSS REFERENCES TO RELATED APPLICATIONS

This disclosure claims the priority of China patent application No. “202111222468.1” filed on Oct. 20, 2021, with the application name of “VIDEO GENERATION METHOD AND APPARATUS, ELECTRONIC DEVICE, AND READABLE STORAGE MEDIUM,” and the entire content of this China patent application is incorporated into this disclosure by reference.

### TECHNICAL FIELD

The application relates to the technical field of video processing, and in particular, relates to a video generation method, apparatus, electronic device and readable storage medium.

### BACKGROUND

With the rapid development of Internet technology, various types of applications (APP) are constantly being developed, among which image processing applications are especially favored by users. Usually, when users edit images with an APP, they first import the images they want to process, then add their favorite filters, stickers, etc., and then export the processed image for saving or sharing.

However, the functions of related image editing applications are usually limited to image editing, which is relatively simple and cannot meet the diversified needs of users.

### SUMMARY

In order to solve the above technical problems or at least partially solve the above technical problems, the present disclosure provides a video generation method, apparatus, electronic device and readable storage medium.

In a first aspect, the present disclosure provides a video generation method, including:
obtaining a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
generating a recorded video of the image editing process on the basis of the plurality of editing process images; wherein a video frame image in the recorded video includes the plurality of editing process images, and a time sequence of the plurality of editing process images in the recorded video corresponds to an editing sequence in the image editing process.

As one possible embodiment, in the image editing process for the image to be processed, obtaining a plurality of editing process images includes:

in the image editing process for the image to be processed, for respective target image editing operations, obtaining the image obtained after the execution of the target image editing operation as the editing process image.

As one possible implementation, before obtaining the image obtained after the execution of the target image editing operation as the editing process image, the method further includes:
receiving a confirmation operation for the target image editing operation; and
in response to the confirmation operation, obtaining the image obtained after the target image editing operation is executed, as the editing process image.

As one possible embodiment, the method further includes:
receiving an undo operation for the target image editing operation; and
in response to the undo operation, deleting the editing process image obtained after the target image editing operation is executed.

As one possible embodiment, the method further includes:
receiving a redo operation for the target image editing operation; and
in response to the redo operation, obtaining the image obtained after the target image editing operation is executed, as the editing process image.

As one possible implementation, the plurality of editing process images further include the image to be processed, and the image to be processed is a first video frame image of the recorded video.

As a possible embodiment, the plurality of editing process images further include images obtained through the plurality of image editing operations sequentially executed for the image to be processed, and the image obtained through the plurality of image editing operations sequentially executed for the image to be processed is a last video frame image of the recorded video.

In a second aspect, the present disclosure provides a video generation apparatus, including:
an obtaining module, configured to obtain a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
a processing module, configured to generate a recorded video of the image editing process on the basis of the plurality of editing process images; wherein the video frame image in the recorded video includes the plurality of editing process images, and a time sequence of the plurality of editing process images in the recorded video corresponds to an editing sequence in the image editing process.

In a third aspect, the present disclosure provides an electronic device including a memory and a processor;
the memory is configured to store computer program instructions; and
the processor is configured to execute the computer program instructions, so that the electronic device realizes the video generation method according to any one of the first aspects.

In a fourth aspect, the present disclosure provides a readable storage medium including: computer program instructions; the computer program instructions, when executed by at least one processor of an electronic device, cause the electronic device to realize the video generation method according to any one of the first aspects.

In a fifth aspect, the present disclosure provides a computer program product which, when executed by a computer, causes the computer to realize the video generation method according to any one of the first aspects.

The application provides a video generation method, apparatus, electronic device and readable storage medium, wherein the method includes: obtaining a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; generating a recorded video of the image editing process on the basis of the plurality of editing process images; wherein a video frame image in the recorded video includes the plurality of editing process images, and a time sequence of the plurality of editing process images in the recorded video corresponds to an editing sequence in the image editing process. The method provided by the present disclosure can meet the diversified needs of users by generating recorded videos that can show the image editing process. In addition, converting the image editing process into a video is beneficial to improve the enthusiasm of users to share the image editing process.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure.

In order to explain the technical scheme in the embodiment of the present disclosure or related technology more clearly, the drawings needed in the description of the embodiment or related technology will be briefly introduced below. Obviously, for ordinary people in the field, other drawings can be obtained according to these drawings without paying creative labor.

FIGS. 1A to 1G are human-computer interaction interface diagrams provided by embodiments of the present disclosure;

FIG. 2 is a flowchart of a video generation method provided by an embodiment of the present disclosure;

FIG. 3 is a flowchart of a video generation method provided by another embodiment of the present disclosure;

FIG. 4 is a flowchart of a video generation method provided by another embodiment of the present disclosure;

FIG. 5 is a flowchart of a video generation method provided by another embodiment of the present disclosure;

FIG. 6 is a structural diagram of a video generation apparatus provided by an embodiment of the present disclosure; and

FIG. 7 is a schematic structural diagram of an electronic device provided by an embodiment of the present disclosure.

### DETAILED DESCRIPTION

In order to understand the above objects, features and advantages of the present disclosure more clearly, the scheme of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein; obviously, the embodiments in the specification are only part of the embodiments of the present disclosure, not all of them.

Illustratively, the present disclosure provides a video generation method, apparatus, electronic device, readable storage medium and computer program product, wherein the method includes the following steps. A plurality of editing process images in an image editing process is obtained for an image to be processed; the image editing process includes a plurality of image editing operations sequentially executed for the image to be processed, wherein the plurality of editing process images are images obtained after executing different target image editing operations among the plurality of image editing operations on the image to be processed in the image editing process; a recorded video of the image editing process is generated on the basis of the plurality of editing process images; a video frame image in the recorded video includes the plurality of editing process images, and a time sequence of the plurality of editing process images in the recorded video corresponds to an editing sequence in the image editing process. The method provided by the present disclosure can meet diversified needs of users by generating recorded videos that can show the image editing process. In addition, converting the image editing process into a video is beneficial to improve the enthusiasm of users to share the image editing process.

The recorded video of the image editing process mentioned in this disclosure can also be called review video, editing process video, target video and other names, and this disclosure does not limit the names of videos generated on the basis of multiple editing process images.

The editing review function mentioned in this disclosure is a function of obtaining a plurality of editing process images in the image editing process, and generating a recorded video of the image editing process on the basis of the plurality of editing process images.

In addition, it should be noted that the image editing process includes a plurality of image editing operations that are sequentially executed for the image to be processed, and the plurality of editing process images used for generating recorded video are images obtained after executing different target image editing operations among the plurality of image editing operations on the image to be processed in the image editing process. A number of the images in the editing process may be equal to or less than the number of the image editing operations. That is to say, the images obtained after each image editing operation are not necessarily all used to generate recorded video, but only a part of the images obtained after each image editing operation may be used to generate recorded video, or each of the images obtained after each image editing operation may be used to generate recorded video.

Illustratively, the video generation method provided by the present disclosure can be executed by an electronic device. The electronic device may be a tablet computer, a mobile phone (such as a folding screen mobile phone, a large screen mobile phone, etc.), a wearable device, a vehicle-mounted device, an Augmented Reality (AR)/Virtual Reality (VR) device, a notebook computer, an Ultra-mobile Personal Computer (UMPC), netbooks, Personal Digital Assistant (PDA), smart TVs, smart screens, high-definition TVs, 4K TVs, smart speakers, smart projectors and the Internet of Things (IOT) devices. This disclosure does not impose any restrictions on the specific types of electronic devices.

In this disclosure, the type of an operating system of the electronic device is not limited. For example, it may be Android system, Linux system, Windows system, iOS system and so on.

On the basis of the foregoing description, the embodiment of the present disclosure takes the electronic device as an example, and elaborates the video generation method provided by the present disclosure in detail with the attached drawings and application scenarios.

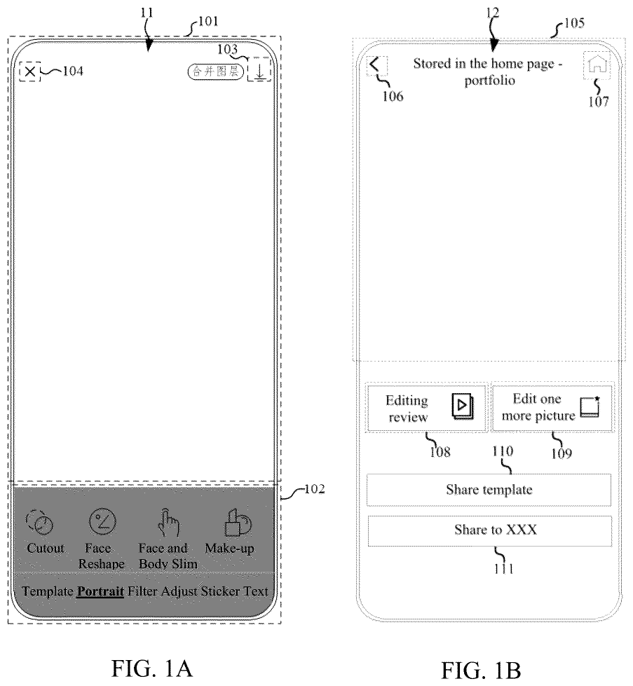

With reference to FIGS. 1A to 1G, the implementation process of the video generation method provided by the present disclosure is introduced. For the convenience of explanation, the electronic device is a mobile phone, and an image editing application program (hereinafter referred to as Application 1) is installed in the mobile phone.

FIGS. 1A to 1G are schematic diagrams of human-computer interaction interfaces provided by embodiments of the present disclosure.

When editing an image to be processed, the Application 1 can exemplarily display a user interface 11 as shown in FIG. 1A on the mobile phone, wherein the user interface 11 is used to show an image editing page.

It should be noted that this disclosure does not limit the images to be processed, for example, the images to be processed may include photos already taken in the mobile phone, pre-downloaded photos, real-time photos and so on.

In addition, users may enter the image editing page through a portal provided in a home page of Application 1, or users may enter the image editing page by re-editing the works in a portfolio of Application 1, or users may enter the image editing page by re-editing the works in a draft box of Application 1. The present disclosure does not limit the implementation of entering the image editing page.

Referring to FIG. 1A, the user interface 11 may include: an area 101, an area 102, an entry 103 and a control 104.

The area 101 is an image preview area, which is used to show the imported image to be processed and a preview image editing effect during image editing of the image to be processed. This disclosure does not limit the size, display position, shape and other parameters of the area 101. For example, as shown in FIG. 1A, the area 101 may be rectangular and located in a middle area of the user interface 11, and the shape of the area 101 may also be related to the shape of the image to be processed.

The area 102 is used to show some portals or controls corresponding to image processing functions and function panels corresponding to the portals or controls. For example, referring to FIG. 1A, the area 102 may include an entrance for entering a template display panel, an entrance for entering a portrait function display panel, an entrance for entering a filter display panel, an entrance for entering a sticker display panel, an entrance for entering a graffiti pen function panel, an entrance for entering a text display panel, an entrance for performing a background function display panel, a control for importing pictures, and the like.

In some embodiments, when entering the image editing page, the users can navigate to a certain portal by default, and the page corresponding to the portal is displayed. After that, the corresponding page can be displayed on the basis of the operation of other portals. For example, in the embodiment shown in FIG. 1A, the users navigate to the entrance for entering the portrait function display panel, and the corresponding portrait function display panel is displayed in the area 102.

The users can edit the images to be processed through the portals and controls provided in the area 102. In the process of image editing, the application 1 can obtain the image obtained after the target editing operation is executed as the editing process image for the generating of recorded video, wherein how the application 1 obtains multiple editing process images will be described in detail in the following embodiments.

The entrance 103 is used to enter a successful saving page to save the image displayed in the area 101. The present disclosure does not limit the implementation of the portal 103, wherein the portal 103 can be implemented by one or more ways such as icons, characters, images, symbols, etc. For example, as shown in FIG. 1A, the portal 103 is implemented by icons. In addition, the present disclosure does not limit the display parameters such as the size, display position and color of the entrance 103.

The control 104 is used to exit the image editing page. For example, if the application 1 receives a trigger operation (such as a click operation) on the control 104, the application 1 can jump to the home page of the application 1 from the image editing page. Of course, the application 1 can switch to other pages after receiving the trigger operation of the control 104, and this disclosure does not limit this.

In addition, the present disclosure does not limit the implementation of the control 104, for example, the control 104 can be implemented in one or more ways such as icons, characters, images, symbols, etc. In addition, this disclosure does not limit the display parameters such as the size, display position, color, etc. of the control 104.

Upon receiving a trigger operation (such as a click operation) on the portal 103, the application 1 exports and saves the image obtained through multiple image editing operations sequentially executed for the image to be processed (hereinafter, the image obtained through multiple image editing operations sequentially executed for the image to be processed will be referred to as the target image), wherein saving the target image by the application 1 may include saving the target image to the mobile phone locally by the application 1, saving the target image to the portfolio of the application 1, and so on.

In addition, when the application 1 successfully saves the target image, the application 1 can exemplarily display the user interface 12 as shown in FIG. 1B on the mobile phone, and the user interface 12 is mainly used to show the successful saving page.

Referring to FIG. 1B, the user interface 12 includes: an area 105, a control 106, an entrance 107 and an entrance 108.

The area 105 is used for displaying the target image. This disclosure does not limit the display parameters such as the size, display position and shape of the area 105. For example, referring to FIG. 1B, the shape and the size of the area 105 are matched with the shape and the size of the target image, and the area 105 may be located near the top in the user interface 12.

The control 106 is used for returning to the image editing page. For example, if the application 1 receives a trigger operation (such as a click operation) for the control 106, the application 1 can jump from the successful saving page to the image editing page shown in the user interface 11. The present disclosure does not limit the implementation and display parameters of the control 106.

The portal 107 is used to enter the home page of the application 1. The present disclosure does not limit the implementation of the portal 107, wherein the portal 107 can be implemented by one or more ways such as icons, characters, images, symbols, etc. For example, as shown in FIG. 1B, the portal 107 is implemented by icons. In addition, the present disclosure does not limit the display parameters such as the size, display position and color of the entrance 107.

The entrance 108 is used to trigger the application 1 to load a plurality of editing process images obtained in the image editing process, generate a recorded video, and enter a video clipping page. The present disclosure does not limit the implementation of the portal 108, and the portal 108 can be implemented by one or more ways such as icons, characters, images, symbols, etc. For example, as shown in FIG. 1B, the portal 108 is implemented by the way of “characters+icons,” wherein text content is illustratively “editing review.”

In addition, this disclosure does not limit the size, display position, icon color, text color, color of the area where the portal 108 is located, font, font size, icon style and other parameters of the portal 108. For example, referring to FIG. 1B, the portal 108 is located below the area 105.

In some embodiments, the user interface 12 further includes: an entrance 109.

The entrance 109 is used to enter an image material display page, wherein the image material display page is used for displaying thumbnail image material, and the user can select the image material in the image material display page for image editing. The present disclosure does not limit the implementation of the portal 109, and the portal 109 can be implemented by one or more ways such as icons, characters, images, symbols, etc. For example, as shown in FIG. 1B, the portal 109 is implemented by the way of “characters+icons,” wherein the text content is exemplarily “editing one more.”

In addition, this disclosure does not limit the size, display position, icon color, text color, color of the area where the portal 109 is located, font, font size, icon style and other parameters of the portal 109. For example, referring to FIG. 1B, the portal 109 is located below the area 105.

For example, the entrance 108 and the entrance 109 may be horizontally aligned, as shown in FIG. 1B. Alternatively, the entrance 108 and the entrance 109 may also be displayed in a vertically aligned manner.

In some embodiments, the user interface 12 may also include: a control 110 and a portal 111.

Herein, the control 110 is used for publishing the target image as an image editing template. The portal 111 is used to share the target image to a target platform. The present disclosure does not limit the implementation and display parameters of the control 110 and the portal 111.

On the basis of the embodiment shown in FIG. 1B, in response to the trigger operation of the portal 108, the application 1 loads a plurality of editing process images obtained in the image editing process, and generates a recorded video of the image editing process.

If it takes a long time for the application 1 to load the obtained multiple editing process images and generate the recorded video on the basis of the multiple editing process images, the application 1 may display the preset loading dynamic effect in the process of loading multiple editing process images and generating the recorded video. And when the loading and generating of the recorded video are completely finished, the application 1 stops displaying the preset loading dynamic effect and jumps to the video clipping page.

Herein, the present disclosure does not limit the implementation of the preset loading dynamic effect (hereinafter referred to as loading dynamic effect), for example, the loading dynamic effect may be realized by one or more ways such as images, characters, animations, etc. Illustratively, the application 1 exemplarily displays a user interface 13 as shown in FIG. 1C on a mobile phone.

Referring to FIG. 1C, the user interface 13 includes: an area 112, which is mainly used to show the dynamic effect of loading. This disclosure does not limit the display parameters such as the display position, size, color, transparency, etc. of the area 112. For example, as shown in FIG. 1C, a loading circle 112a and the text content “video is being generated” are displayed in the area 112, wherein the loading circle 112a corresponds to the overall progress of loading key frames and clips, and the loading circle 112a is shown as a black bar in FIG. 1C.

In addition, on the basis of the embodiment shown in FIG. 1C, the user interface 13 may also include an area 112b, which may display a cover of the generated recorded video, for example, the first video frame image of the recorded video, i.e. the image to be processed, so as to enhance the user's visual experience.

In other embodiments, if it takes shorter time for the application 1 to load the obtained multiple editing process images and generate recorded videos on the basis of the multiple editing process images, the application 1 may skip from the successful saving page to the video clipping page without showing the preset loading effect.

The application 1 may exemplarily display the user interface 14 shown in FIG. 1D on the mobile phone, wherein the user interface 14 is used to show the video clipping page.

Referring to FIG. 1D, the user interface 14 includes: an area 113, a control 114, a control 115, a portal 116 and a control 117.

The area 113 is used to show a recorded video preview page. The present disclosure does not limit the display parameters such as the display size, display position, display shape, etc. of the area 113. The display parameters of the area 113 may be related to the image size of the recorded video.

The control 114 is used to return to the successful saving page. For example, in response to the trigger operation (such as the click operation) of the control 114, the application 1 may be exemplarily switched from the user interface 14 shown in FIG. 1D to the user interface 12 shown in FIG. 1B.

The present disclosure does not limit the implementation of the control 114, and the control 114 may be implemented in one or more ways such as icons, characters, images and symbols. And this disclosure does not limit the display parameters such as the display size, display position, color, etc. of the control 114.

The control 115 is used to trigger the application 1 to export and store the video. If the recorded video is not edited on the video editing page, the exported and stored video is the recorded video; if the recorded video is edited on the video editing page, the exported and stored video is the edited recorded video.

In some embodiments, the application 1 may support turning watermarking on or off. If watermarking is turned off, when the video is exported through the control 115, the watermark corresponding to the application 1 is not added to the video; if watermarking is turned on, when the video is exported through the control 115, the watermark corresponding to the application 1 is added to each video frame image of the video. The present disclosure does not limit whether to add a watermark.

Illustratively, in response to the trigger operation (such as the click operation) of the control 115, the application 1 may switch to a video successful saving page by the user interface 14 shown in FIG. 1D, wherein the present disclosure does not limit the implementation of the video successful saving page.

The present disclosure does not limit the implementation of the control 115, and the control 115 may be implemented in one or more ways such as icons, characters, images, symbols, etc. And this disclosure does not limit the display parameters such as the display size, display position, color, etc. of the control 115.

In some embodiments, as shown in FIG. 1D, there is no overlap between the display positions of the control 114 and the control 115 and the area 113. In other embodiments, the display positions of the controls 114 and 115 may overlap with the area 113, and the controls 114 and 115 may be displayed on the upper layer of the area 113 in a floating manner.

The portal 116 is used for displaying music library pages. Users may add background music to recorded videos through the music provided by a music library. The portal 116 may be realized in one or more ways, such as icons, characters, images, symbols, etc. And this disclosure does not limit the display parameters such as the display size, display position, color, etc. of the portal 116.

The control 117 is used to enter a speed adjustment panel, through which a playing speed of the video has been adjusted. Illustratively, the application 1 receives the trigger operation (such as the click operation) on the control 117, and the application 1 may display the speed adjustment panel.

For example, the user interface 15 shown in FIG. 1E includes an area 118 for displaying the speed adjustment panel. The area 118 may include a control 118a, a speed adjustment slider 118b, a control 118c for exiting the speed adjustment panel, and a control 18d for confirming the use of the currently selected playing speed.

Herein, the control 118 includes two states, the first state corresponds to a uniform speed mode, and the second state corresponds to a synced-up mode. The user may switch back and forth between the first state and the second state by operating the control 118, and accordingly, the playing speed of the recorded video is switched back and forth between the uniform mode and the synced-up mode.

The speed adjustment slider 118b may provide various playing speeds. For example, as shown in FIG. 1E, the speed adjustment slider 118b may provide three playing speeds, and the playing speeds from slow to fast are slow, normal and fast. In practical application, application 1 may provide more or less playing speeds for users to choose, and the one shown in FIG. 1E is only one example.

After selecting the playing speed to be used through the speed adjustment slider 118b, if the application 1 receives the trigger operation (such as the click operation) for the control 18d, the application 1 confirms to use the currently selected playing speed, and exits the speed adjustment panel to display the user interface 14 shown in FIG. 1D.

In addition, if the application 1 receives the trigger operation (such as the click operation) for the control 118c, it exits the speed adjustment panel and displays the user interface 14 shown in FIG. 1D.

With continued reference to the embodiment shown in FIG. 1D, the user interface 14 may further include an area 119.

The area 119 may include: a control 119a for controlling a preview state of the video to be a play state or a pause state, a play progress bar 119b, and an area 119c for displaying current play time and a total video duration.

Of course, the implementation of the video clipping page is not limited to the embodiments shown in FIG. 1D and FIG. 1E, for example, the video clipping page may also include more editing functions.

In some cases, the application 1 may prompt the user that the application 1 supports the generating of the recorded video of the image editing process by displaying first guiding information, thus improving the user's enthusiasm for using this function. on the basis of this, on the basis of the embodiment shown in FIG. 1A, the application 1 receives the trigger operation on the portal 103, and the application 1 may exemplarily display the user interface 16 as shown in FIG. 1F on the mobile phone.

Referring to FIG. 1F, the user interface 16 includes: an area 120 for displaying the first guiding information. The present disclosure does not limit the display parameters such as the display position, display size and color of the area 120. For example, as shown in FIG. 1F, there may be an overlap between the area 120 and the area 105, and the area 120 is displayed on the upper layer of the area 105 in a floating manner.

Illustratively, the area 120 may include: an area 120a and an area 120b, wherein the area 120a is used for displaying a guide animation, which may be generated according to a plurality of editing process images obtained in the image editing process, and the area 120b is used for displaying a first guide text, as shown in FIG. 1F, which includes text contents “editing review” and “check your editing records.” This disclosure does not limit the display parameters of the first guide text.

In practical application, the present disclosure does not limit a display mode of the first guide information, and the first guide information is not limited to including: guide animation and/or first guide text.

On the basis of the user interface 16 shown in FIG. 1F, the application 1 receives the trigger operation to any position outside the area 120, and the application 1 may control the area 120 to disappear, i.e., return to the user interface 12 shown in FIG. 1B.

In some cases, the application 1 may prompt the user that the application 1 supports the generating of the recorded video of the image editing process by displaying second guidance information, thus improving the user's enthusiasm for using this function. And in order to facilitate the user's operation, the application 1 may set, in a guidance window showing the second guidance information, a portal for triggering the application 1 to load the editing process image and generate the recorded video on the basis of the editing process image.

On the basis of this, on the basis of the embodiment shown in FIG. 1A, the application 1 receives the trigger operation on the portal 103, and the application 1 may exemplarily display the user interface 17 as shown in FIG. 1G on the mobile phone.

Referring to FIG. 1G, the user interface 17 includes: an area 121 for displaying second guidance information. This disclosure does not limit the display parameters such as the display position, display size and color of the area 121. For example, as shown in FIG. 1G, there may be an overlap between the area 121 and the area 105, and the area 121 is displayed on the upper layer of the area 105 in a floating manner.

Illustratively, the area 121 may include: an area 121a, an area 121b, a portal 121c and a portal 121d.

The area 121a is used to rotate a plurality of editing process images obtained during image editing. For example, the plurality of editing process images may be rotated at a preset rate (such as 0.5 seconds per frame). The present disclosure does not limit the display size of the area 121a, the display position of the area 121a in the area 121, and the like. For example, as shown in FIG. 1G, an upper edge of the area 121a overlaps with an upper edge of the area 121, and a left edge of the area 121a overlaps with a left edge of the area 121, while a right edge of the area 121a overlaps with a right edge of the area 121, and the lower edge of the area 121a is located inside the area 121.

In some cases, the user imports the image to be processed, but does not edit the image to be processed. Therefore, the editing process image includes the image to be processed, and the image to be processed may be played circularly at the preset rate in the area 121a.

In some embodiments, the area 121a may also provide a control 121e, which is used to control the play state in the area 121a. Suppose that at present, it is the play state of playing back the editing process images in the area 121a, and the application 1 receives the trigger operation (such as the click operation) on the control 121e, and the application 1 controls the area 121a to pause playback of the editing process images. On this basis, the application 1 receives the trigger operation (such as the click operation) on the control 121e again, and the application 1 controls the area 121a to continue playing back the editing process images from the paused position, so that the user may operate the control 121e to switch from the play state to the pause state when key frames are played back in the area 121a.

The area 121b is used to show a second guide text. The present disclosure does not limit the text content, display parameters, etc. of the second guide text. For example, as shown in FIG. 1G, the second guide text is “XXXXXXXXXXX,” and the area 121b is located below the area 121a.

The portal 121c is used for triggering the application 1 to load the plurality of editing process images obtained in the image editing process and generate the recorded video on the basis of the plurality of editing process images, and for triggering the application 1 to share the recorded video to the target platform after the recorded video is generated.

In some embodiments, the application 1 receives the trigger operation (such as the click operation) on the portal 121c, loads the plurality of editing process images obtained in the image editing process, and generates the recorded video on the basis of the plurality of editing process images. In the process of loading and generating the recorded video, the application 1 may show a preset video loading effect and a control for canceling sharing. When the recorded video is generated, the mobile phone may start the target application to share the recorded video to the target platform.

In the process of loading a plurality of editing process images obtained in the image editing process and generating the recorded video on the basis of the plurality of editing process images, if the application 1 receives the trigger operation (such as the click operation) for canceling sharing, the application 1 returns to display the video clipping page, and the area 121 may always be displayed on the video clipping page, so as to facilitate the user to operate the portal 121c or the portal 121d again to generate the recorded video.

In addition, the application 1 receives the trigger operation on the portal 121c, and when the recorded video is generated, the application 1 may also save the recorded video to the mobile phone locally and the portfolio of the application 1.

The portal 121d is used for triggering the application 1 to load the plurality of editing process images obtained in the image editing process, and generate the recorded video on the basis of the plurality of editing process images, and for triggering the application 1 to enter the video clipping page after the recorded video is generated. Illustratively, the application 1 receives the trigger operation (such as the click operation) on the portal 121d, and the application 1 may exemplarily display the user interface 14 as shown in FIG. 1D on the mobile phone to further edit the recorded video.

The present disclosure does not limit the implementation and display parameters of the portal 121c and the portal 121d.

In addition, on the basis of the user interface 17 shown in FIG. 1G, the application 1 receives the trigger operation at any position other than the area 121, and the application 1 may control the area 121 to disappear, i.e., return to the user interface 12 shown in FIG. 1B.

In combination with the embodiments shown in FIG. 1F and FIG. 1G, the application 1 may display the first guide information and the second guide information to prompt the user that the application 1 currently supports the generating of the recorded video of the image editing process. The application 1 may determine whether to display the first guide information or the second guide information when jumping from the image editing page to a successful saving page through a preset trigger mechanism.

The present disclosure does not limit the preset trigger mechanism. In some embodiments, the preset trigger mechanism exemplarily includes:

(a) whether to enter the image editing page through an anchor point provided in the preset h5 page to edit the image to be processed; (b) whether to enter the image editing page within a preset time after browsing the preset h5 page to edit the image to be processed; (c) whether to use a preset image editing function, such as a graffiti pen function, during the image editing process of the image to be processed; and (d) whether to enter the image editing page through the preset anchor point to edit the image to be processed.

It should be noted that the above h5 page may include the h5 page corresponding to some activities in the application 1; and the preset anchor point may include the anchor point set in the home page of application 1, the anchor point set in a recommendation page, and so on.

If any of the trigger mechanisms (a) to (d) is satisfied, the second guidance information is displayed.

In addition, the display of the guidance window is triggered by any of the trigger mechanisms (a) to (d) above, and the second guidance information displayed in the guidance window may be different. For example, if the user enters the image editing page through an anchor point provided in the h5 page corresponding to the activity, the guidance window may show “Try to share your editing process and participate in the activity.” If the user uses a graffiti pen function in the image editing process, the guidance window may show “Try to share the graffiti effect and get more attention.”

If the trigger mechanism is not satisfied, the first guiding information is displayed. For a scene that does not meet the above trigger mechanism, for example, the user starts the application 1, enters the image material display interface through the import control on the home page of the application 1, selects the image to be processed, and then jumps to the image editing page to edit the image to be processed. When the image editing ends and enters the successful saving page, the first guide information is displayed. For another example, the user starts the application 1, enters the portfolio, chooses to continue image editing for a certain work in the portfolio, and displays the first guiding information when the image editing ends and enters the successful saving page.

It should be noted that the above preset trigger mechanism is only an example, not a limitation of the preset trigger mechanism, and it may be flexibly set according to the requirements in practical application.

In combination with the aforementioned embodiments shown in FIGS. 1A to 1G, the video generation method provided by the present disclosure obtains a plurality of editing process images during the image editing process for the image to be processed; the image editing process includes a plurality of image editing operations sequentially executed for the image to be processed, wherein the plurality of editing process images are images obtained after the image to be processed is executed by different image editing operations in the image editing process; a recorded video of the image editing process is generated on the basis of the plurality of editing process images; the video frame image in the recorded video includes the plurality of editing process images, and the time sequence of the plurality of editing process images in the recorded video corresponds to the editing sequence in the image needs of users by generating recorded videos that may show the image editing process. In addition, converting the image editing process into video is beneficial to improve the enthusiasm of users to share the image editing process.

Illustratively, the present disclosure provides a video generation method.

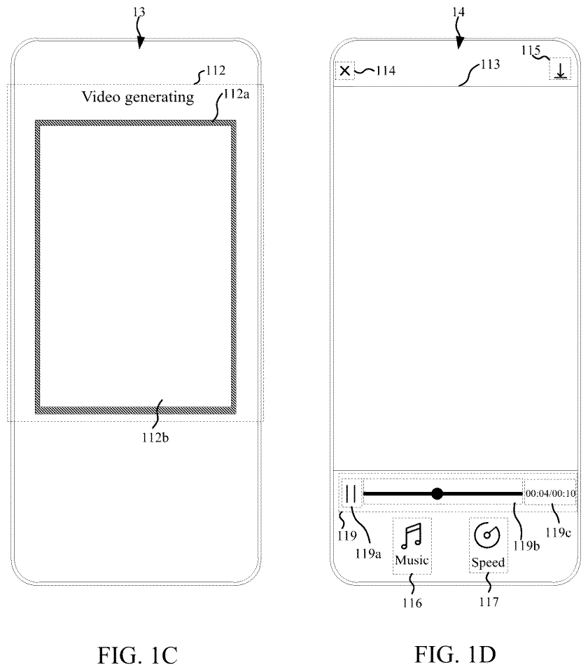

FIG. 2 is a flowchart of a video generation method provided by an embodiment of the present disclosure. Taking the electronic device as an example, the method provided by this embodiment is described in detail.

Referring to FIG. 2, the method provided by this embodiment includes the following steps:

S201: In an image editing process for an image to be processed, a plurality of editing process images are obtained; the image editing process includes a plurality of image editing operations sequentially executed for the image to be processed, and the plurality of editing process images are images obtained after executing different target image editing operations among the plurality of image editing operations on the image to be processed in the image editing process.

An application program is installed in the electronic device, and the electronic device starts the application program and enters the image editing page for image editing of the image to be processed, so as to edit the image to be processed.

The present disclosure does not limit the image to be processed. For example, the image to be processed may be a shot photo stored in the electronic device, a photo taken in real time using the application, a pre-downloaded picture stored in the electronic device, an image in a portfolio of the application, an image in a draft box of the application, and the like.

The present disclosure does not limit the implementation of the image editing page. Herein, the image editing page may be exemplified as the aforementioned embodiment shown in FIG. 1A, and the detailed description of the aforementioned embodiment shown in FIG. 1A may be referred to, which is not repeated here for brevity.

During the image editing process of the image to be processed, the application program may record multiple images of the editing process, which is used to generate the recorded video during the image editing process. Herein, the image editing process may include a plurality of image editing operations that are sequentially performed on the image to be processed. The application program may record the image obtained after executing different target image editing operations among the plurality of image editing operations on the image to be processed as the editing process image. i.e., the plurality of different image editing operations include different target image editing operations.

In some embodiments, the image obtained after the execution of each image editing operation may be recorded as the editing process image, i.e., different target image editing operations include each of a plurality of image editing operations.

In other embodiments, the image obtained after the execution of part of the plurality of image editing operations may be recorded as the editing process image. i.e., different target image editing operations include part of the plurality of image editing operations.

In practical application, the above two methods may be flexibly selected. For example, in some cases, if a number of steps of image editing operations performed by users is small, the images obtained after each image editing operation may be recorded as editing process images, so that the generated recorded video may show the complete image editing process and content richness of the recorded video may be improved; in other cases, if the number of steps of image editing operations performed by users is large, and the images obtained after some image editing operations are similar, etc., a part of the images obtained after image editing operations are selectively not recorded as editing process images, which can, on the basis of showing the image editing process by the recorded video, avoid the situation that the recorded video cannot meet the user's expectations due to the long duration of the generated recorded video or too many similar contents.

In addition, the multiple editing process images used to generate the recorded video also include the imported image to be processed, and the image to be processed is the first video frame image of the recorded video.

In addition, the multiple editing process images used to generate the recorded video also include images obtained through multiple image editing operations sequentially performed on the images to be processed, i.e., the target image in the previous article, and the target image is the last video frame image of the recorded video.

On the above basis, some specific image editing operations may be recorded according to corresponding strategies.

S202: A recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process.

In some embodiments, the application program may provide a target portal for triggering the generating of the recorded video, and on the basis of the user's triggering operation on the target portal, a plurality of editing process images are loaded by the application program, and the recorded video of the image editing process is generated on the basis of the loaded plurality of editing process images.

For example, after the plurality of image editing operations are sequentially executed for the image to be processed, the target image may be saved on the basis of the trigger operation input by the user. When the target image is successfully saved, the application program may display the successful saving page, and the successful saving page may display the target portal that triggers the application program to generate the target portal of the recorded video according to a plurality of editing process images. For example, as shown in the embodiment shown in FIG. 1B, the successful saving page may be realized by triggering the application to load a plurality of editing process images through the portal 103, and generating the recorded video of the image editing process on the basis of the plurality of editing process images. For the specific implementation of the successful saving page and the portal 103, please refer to the detailed description of the embodiment shown in FIG. 1B, and for the sake of brevity, it will not be repeated here.

On the basis of the embodiment shown in FIG. 1B, when the application displays the successful saving page, it may also display guidance information to prompt the user that the application supports the generating of recorded video in the image editing process. For example, the successful saving page may be realized as shown in the embodiment shown in FIG. 1F, and first guidance information may be displayed through the area 120, and may include the guidance animation and the first guidance text.

In some cases, when the application displays the successfully successful saving page, the guide window is displayed in the successfully successful saving page, and in the guidance window, a plurality of editing process images may be played back, and the second guide text may be displayed in the guide window, and a specific portal or control may be set for the user to operate. For example, the implementation of saving the successful page may be as shown in the embodiment of FIG. 1G. A plurality of editing process images are rotated through the area 121a, and the second guide text is displayed in the area 121b; the portal 121c is set to trigger the application to load the plurality of editing process images, and the recorded video of the image editing process is generated on the basis of the plurality of editing process images, and the recorded video is shared on the target platform; and the portal 121d is set to trigger the application to load the plurality of editing process images and generate the recorded video of the image editing process on the basis of the plurality of editing process images, and then the user may enter the video clipping page.

For example, when the successful saving page is realized through the embodiment shown in FIG. 1G, the user may enter the video clipping page by operating the portal provided by the guidance window, without exiting the guidance window and then entering the video clipping page through the portal 103. The method shown in FIG. 1G is simple and convenient, and may reduce the number of steps operated by the user and improve the user experience.

In other embodiments, after the plurality of image editing operations are sequentially executed for the images to be processed and the target image is saved, a plurality of editing process images may be automatically loaded, and the recorded video of the image editing process may be generated on the basis of the plurality of editing process images.

In addition, the present disclosure does not limit the implementation of the recorded video of the image editing process on the basis of the plurality of editing process images.

In some embodiments, the application program may upload the plurality of loaded editing process images to the server through the electronic device, and the server clips the plurality of editing process images into the recorded video, and then the recorded video is sent to the electronic device at the server.

In other embodiments, the application program may clip multiple editing process images into the target video locally on the electronic device.

Herein, the server or the electronic device may clip the plurality of editing process images according to the video editing template, or the clipping mode may be determined by extracting the characteristics of the editing process images in specific dimensions, and then the editing process images may be clipped according to the determined clipping mode; and alternatively, the plurality of editing process images may be played at a preset speed.

In addition, when the recorded video is generated according to the plurality of editing process images, background music may also be added to the recorded video, wherein the background music may be popular music, music in the top of a ranking list, music with high attention and the like, and the disclosure does not limit the background music. After that, the user may enter a music library through the portal for entering the music library in the video clipping page, select other favorite background music, and replace the automatically added background music.

In addition, each video frame image in the recorded video may be independent of the position of the background music, i.e., each video frame image may be played at the preset playing speed, such as playing at a uniform speed; and alternatively, each video frame image may also be matched with the point of background music and played according to the point of background music, i.e., the generated recorded video is a synced up video.

It should be noted that no matter what method is adopted to clip the plurality of editing process images into the recorded video, the video frame images of the recorded video include the above-mentioned editing process images, and the time sequence of the editing process images in the recorded video is consistent with the editing sequence in the image editing process, so as to ensure that the image editing process displayed in the recorded video is consistent with the actual image editing process of the user, thereby improving the user experience.

In the method provided by this embodiment, a plurality of editing process images are obtained in an image editing process for a image to be processed; the image editing process includes a plurality of image editing operations sequentially executed for the image to be processed, wherein the plurality of editing process images are images obtained after the image to be processed is executed in different image editing operations in the image editing process; a recorded video of the image editing process is generated on the basis of the plurality of editing process images; a video frame image in the recorded video includes the plurality of editing process images, and a time sequence of the plurality of editing process images in the recorded video corresponds to an editing sequence in the image editing process. The method provided by the present disclosure may meet the diversified needs of users by generating recorded videos that may show the image editing process. In addition, converting the image editing process into a video is beneficial to improve the enthusiasm of users to share the image editing process.

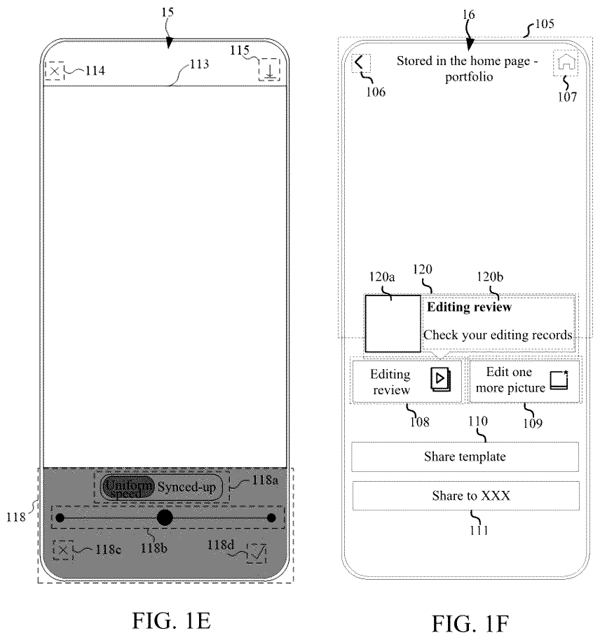

FIG. 3 is a flowchart of a video generation method provided by another embodiment of the present disclosure. Referring to FIG. 3, the method provided by this embodiment includes:

S301: In the process of image editing for the image to be processed, the target image editing operation is executed among the target image editing operations, and the image obtained after the execution of the target image editing operation is obtained.

S302: The image obtained after the execution of the target image editing operation is obtained as the editing process image.

Herein the target image editing operation is the image editing operation to record the corresponding image processing results. As mentioned above, different target editing operations for obtaining the plurality of editing process images may include all the image editing operations performed for the image to be processed, or may also include all the image editing operations performed for the image to be processed.

When the plurality of image editing operations are sequentially executed for the image to be processed, if the target image editing operation is performed, the image obtained after the execution of the target image editing operation may be recorded as the editing process image, and is used for generating the recorded video.

S303: The recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process.

The step S303 in this embodiment is similar to step S202 in the embodiment shown in FIG. 2. Please refer to the detailed description of step S202 in the embodiment shown in FIG. 2, and for brevity, it will not be repeated here.

In the method provided by this embodiment, the plurality of editing process images are obtained in the image editing process for the image to be processed; the image editing process includes the plurality of image editing operations sequentially executed for the image to be processed, wherein the plurality of editing process images are images obtained after the execution of the image to be processed in different image editing operations in the image editing process; the recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process. The method provided by the present disclosure may meet the diversified needs of users by generating recorded videos that may show the image editing process. In addition, converting the image editing process into a video is beneficial to improve the enthusiasm of users to share the image editing process.

When obtaining multiple editing process images, it may be determined whether to record the images obtained after the image editing operation as editing process images according to different image editing operations according to the preset strategy. For example, for this kind of image editing operation without confirmation, the image obtained after the image editing operation may be automatically recorded as the editing process image. Second, for this kind of image editing operation that needs to be confirmed, it may be necessary to determine whether to use the image after the target image editing operation on the basis of the user's confirmation. Therefore, when receiving the confirmation instruction for this image editing operation, the image obtained after the image editing operation may be recorded as the editing process image.

In some embodiments, S302′: a confirmation operation for the target image editing operation is received.

The present disclosure does not limit the implementation of the electronic device to obtain the confirmation operation for the target image editing operation. When the application program receives the confirmation operation, it may make the application program confirm that the image obtained through the executed target image editing operation is the image that the user wants, therefore, the image obtained after the execution of the target image editing operation may be recorded as the editing process image for the generating of recorded video.

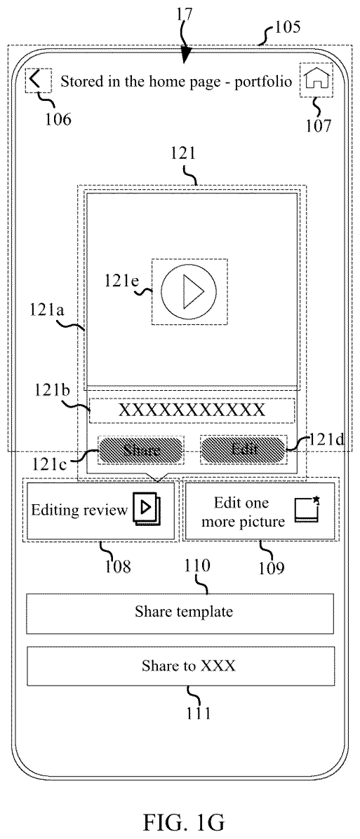

FIG. 4 is a flowchart of a video generation method provided by another embodiment of the present disclosure. Referring to FIG. 4, the method provided by this embodiment includes:

S401: In an image editing process for the image to be processed, for respective target image editing operations, the target image editing operation is executed to obtain the image obtained after the target image editing operation is executed.

S402: The image obtained after the execution of the target image editing operation is obtained as an editing process image.

Herein the target image editing operation is the image editing operation to record the corresponding image processing results. As mentioned above, different target editing operations for obtaining the plurality of editing process images may include all the image editing operations performed for the image to be processed, or may also include all the image editing operations performed for the image to be processed.

The steps S401 and S402 in this embodiment are similar to the steps S301 and S302 in the embodiment shown in FIG. 3, respectively. Please refer to the detailed description of the embodiment shown in FIG. 3, and for brevity, they will not be repeated here.

S403: An undo operation for the target image editing operation is received, and the editing process image corresponding to the target image editing operation is deleted.

In some cases, the user may input one or more undo operations continuously, and then the editing process image obtained after the image editing operation for each undo operation is executed may be deleted from the plurality of recorded editing process images.

S404: The recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process.

The step S404 in this embodiment is similar to the step S202 in the embodiment shown in FIG. 2. Please refer to the detailed description of the step S202 in the embodiment shown in FIG. 2, and for brevity, it will not be repeated here.

In the method provided by this embodiment, the plurality of editing process images are obtained in the image editing process for the image to be processed; the image editing process includes a plurality of image editing operations sequentially executed for the image to be processed, herein the plurality of editing process images are images obtained after the image to be processed is executed in different image editing operations in the image editing process; the recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process. The method provided by the present disclosure may meet the diversified needs of users by generating recorded videos that may show the image editing process. In addition, converting the image editing process into video is beneficial to improve the enthusiasm of users to share the image editing process.

In some cases, after the user inputs the undo operation, a redo operation may also be input. Therefore, it is necessary to record the corresponding image editing process for the redo operation to ensure the consistency between the finally generated recorded video and the image editing process.

In some embodiments, on the basis of the embodiment shown in FIG. 4, after S403, it may further include:

S403′: After a redo operation for the target image editing operation is received, the image obtained after the execution of the target image editing operation is obtained as the editing process image.

That is, the image generated by the redo operation is recorded by the application program as the image of the editing process, so as to ensure that the recorded video may accurately display the image editing process, which is beneficial to improving the user experience.

Herein, the user may input one or more redo operations continuously, and then the image obtained after the execution of the image editing operation for each redo operation may be re-recorded as the editing process image. It should be noted that if the user inputs the redo operation, the undo operation is input before the redo operation, and when the undo operation is received, it may be realized in the manner of S403.

On the basis of the above-mentioned embodiments shown in FIG. 2 to FIG. 4, the implementation strategy of obtaining multiple editing process images will be exemplarily explained below.

It should be noted that in the process of image editing, when obtaining the above-mentioned multiple editing process images, the entire image editing process for the image to be processed needs to be recorded, and the sequence of the multiple editing process images is consistent with the sequence of image editing operations, so as to ensure that the time sequence of each video frame image in the recorded video is consistent with the editing sequence in the image editing process.

In practical application, the image obtained after different target image editing operations are executed may be stored in different image sets as the editing process image. It is assumed that the application program stores the plurality of editing process images through a first image set and a second image set. It should be noted that this disclosure does not limit which image obtained after the execution of the image editing operation is stored by the first image set and the second image set respectively.

It is assumed that when adding image editing templates, filters, adjusting display parameters, special effects, background and other image operations to the image, after performing such image editing operations, the obtained images may be automatically recorded as editing process images and stored in the first image set.

Illustratively, the editing process images included in the first image set may be obtained by the following strategies:

(1) In case of undo operation and redo operation (i.e., when the undo instruction and redo instruction are received), the image obtained after the image editing operation targeted by the redo operation is recorded as the editing process image, and the image obtained after the image editing operation targeted by the undo operation is deleted from the plurality of recorded editing process images.

(2) If the image editing template is added, the image obtained after the adding of the image editing template is recorded as the editing process image; if there is an image editing operation before the image editing template is added, the image editing operation of the original image to be processed is recorded, and the editing process image obtained after other recorded image editing operations are executed is deleted.

(3) When adding filters, adjusting display parameters, special effects, background, etc., the image obtained after the corresponding image editing operation is recorded as a key frame, and when the above image editing is performed again, the corresponding editing process image still needs to be recorded.

It is assumed that when image editing such as portrait image editing, adding stickers, characters and cutout is performed on images, such image editing operations are completed, and the obtained images are recorded as editing process images and stored in the second image set.

Illustratively, the editing process images included in the second image set may be obtained by the following strategies:

(1) When editing portrait images, the following strategies may be used when obtaining the images of the editing process:

A. When performing facial remodeling, the image obtained after performing facial remodeling image operation may be recorded as the editing process image. If facial remodeling is realized by multiple image editing operations, the image obtained after each image editing operation may be recorded as the editing process image.

B. When image editing such as face-lifting and slimming, automatic beautifying, makeup, makeup pen, manual beautifying, hair beautifying, manual body beautifying, erasing pen, automatic body beautifying, facial sharp featuring, etc. is performed, after the image editing operation is performed, when the confirmation operation is received, the image obtained by performing the image editing operation is recorded as the image of the editing process, i.e., only the image when the confirmation operation is received is recorded.

(2) When using the graffiti pen, the following strategies may be used when obtaining the editing process image:

A. Starting from drawing to releasing is one image editing operation, and the images obtained by each image editing operation are recorded as editing process images.

B. When the undo operation and the redo operation occur (i.e., when the undo instruction and the redo instruction are received), the image obtained after the execution of the image editing operation targeted by the redo operation is recorded as the editing process image, and the image obtained after the execution of the image editing operation targeted by the undo operation is deleted from the plurality of recorded editing process images.

C. When graffiti is added with a graffiti pen, the images obtained from the first N image editing operations are recorded as the editing process images, and subsequently, the editing process images may be recorded in a way of discarding every other step.

For example, when graffiti is added with the graffiti pen, each image obtained from the image editing operation among the first 40 image editing operations is recorded, and then for the images from the 41^{st} image editing operation to the 80^{th} image editing operation, once every other image editing operation is recorded, i.e., the images are discarded every other step; and for the images from the 81^{st} image editing operation, the editing process image is recorded every 4 image editing operations, and so on.

Alternatively, other recording methods may be used, and the recording methods shown here are only examples.

D. After graffiti is added with the graffiti pen, if a graffiti position and size are adjusted, the adjusted image is recorded as the editing process image. If the adjusted position and size need to be confirmed by the user, the image when the confirmation operation is received is taken as the editing process image.

It should be noted that the user may adjust the graffiti position and size many times, and may only record the image when the confirmation operation is received as the editing process image.

E. The erasing operation is also used as one image editing operation to record the image in the editing process.

(3) When adding stickers and characters, the following strategies may be used when obtaining the image of editing process:

A. When adding stickers and characters, key frames are recorded; and if the stickers and characters are moved and/or scaled, the moved and/or scaled images are recorded as the editing process images.

If the moving and/or scaling of stickers and characters need to be confirmed by the user, the application program needs to receive the confirmation operation, and the image obtained when the confirmation operation is received is recorded as the editing process image.

B. When adding stickers and characters, if the user needs to confirm, the application program needs to receive the confirmation operation, and the image obtained when the confirmation operation is received is recorded as the editing process image.

C. If the sticker and text are deleted, the application program takes the image record obtained after deleting the sticker and text as the key frame when receiving the deletion operation.

(4) When performing cutout, the application program may fill the background of a cropped image area with a preset color, such as black, and the generated image may be recorded as the editing process image. The strategy for obtaining the editing process image afterwards is similar to the strategy for adding stickers and characters. Please refer to the description in (3) above.
(5) If a new image is imported, the strategy of obtaining the image of the editing process is similar to the strategy of adding stickers and characters. Please refer to the description in (3) for details.

When the editing process image is obtained, an abnormal situation may occur, which may be handled in the following way:

A. There may be some images obtained by image editing operations that cannot be recorded as key frames. Try to record the images obtained when receiving the confirmation operation as key frames. Herein facial remodeling is excluded.

B. In the process of image editing, if the image to be processed or an intermediate image is cropped, then the key frames are recorded with a cropped canvas size. It should be noted that before cutout, key frames are recorded with an original canvas size of the image to be processed.

C. If the similarity between adjacent editing process images is high, some editing process images may be discarded to avoid content repetition in the generated recorded video.

D. If the image editing operation has no image editing effect, but meets the above strategy of recording the image in the editing process, the image in the editing process is not recorded at this time.

E. If some image editing operations are input and the image is edited, but then the corresponding image processing effect is canceled or erased, record normally according to the strategy of obtaining the editing process image corresponding to the above situations.

It should be noted that the present disclosure does not limit the implementation strategy for obtaining the editing process image, and the above implementation strategy for obtaining the editing process image is only an example, not a limitation on the implementation strategy for obtaining the editing process image.

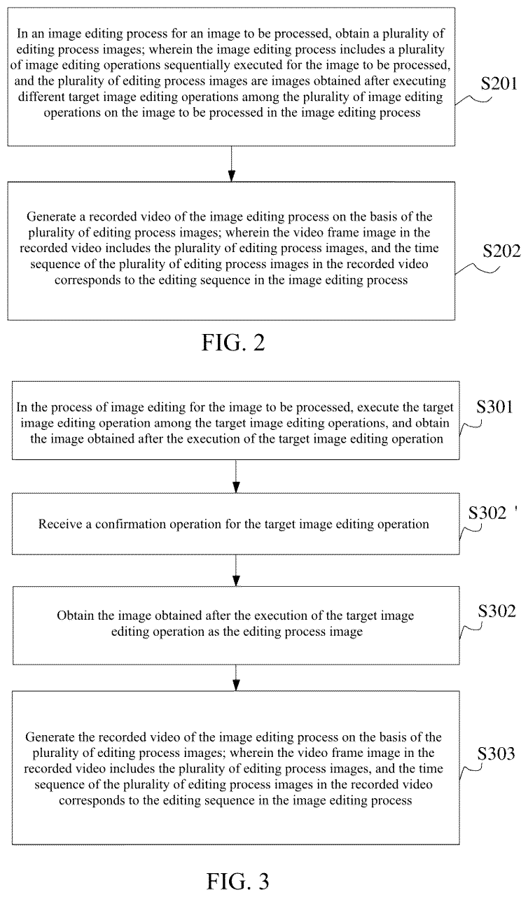

FIG. 5 is a flowchart of a video generation method provided by another embodiment of the present disclosure. Referring to FIG. 5, the method provided by this embodiment includes:

S501: In the image editing process for the image to be processed, the plurality of editing process images are obtained; the image editing process includes the plurality of image editing operations sequentially executed for the image to be processed, and the plurality of editing process images are images obtained after executing different target image editing operations among the plurality of image editing operations on the image to be processed in the image editing process.

S502: The recorded video of the image editing process is generated on the basis of the plurality of editing process images; the video frame image in the recorded video includes the plurality of editing process images, and the time sequence of the plurality of editing process images in the recorded video corresponds to the editing sequence in the image editing process.

Steps S501 and S502 included in this embodiment are similar to steps S201 and S202 in the embodiment shown in FIG. 2, respectively. Please refer to the detailed description of the embodiment shown in FIG. 2, which will not be repeated here for brevity.

S503: The recorded video in the image editing process is edited to obtain the edited recorded video.

When the generating of the recorded video is finished, the application program may display a video clipping page on the display screen of the electronic device, and the implementation of the video clipping page is exemplified by the embodiment shown in FIG. 1D and FIG. 1E.

The application program receives the trigger operation of the portal or control corresponding to the video editing function in the video editing page, and edits the recorded video. For example, referring to the embodiment shown in FIG. 1D, the user may enter a music library page through a portal 116 and select the favorite music for the recorded video as the current background music. For another example, the user may enter a speed adjustment panel through a control 117, and adjust the playing mode and playing speed of the recorded video by using a control 118a for switching the playing mode of the recorded video, a speed adjustment slider 118b, a control 118c for exiting the speed adjustment panel and a control 118d for confirming the currently selected playing speed.

It should be noted that the video editing page may also provide more video editing functions, such as a function of adding stickers, a function of adding words, etc. Here, the video editing functions provided by the video editing page may be flexibly set according to requirements.

In the method provided by this embodiment, the plurality of editing process images are obtained in the image editing process for the image to be processed; the image editing process includes the plurality of image editing operations sequentially executed for the image to be processed, wherein the plurality of editing process images are images obtained after the image to be processed is executed by different image editing operations in the image editing process; the recorded video of the image editing process is generated on the basis of the plurality of editing process images; the video frame image in the recorded video includes the plurality of editing process images, and the time sequence of the plurality of editing process images in the recorded video corresponds to the editing sequence in the image needs of users by generating recorded videos that may show the image editing process. In addition, converting the image editing process into video is beneficial to improve the enthusiasm of users to share the image editing process. In addition, when the recorded video is generated, the electronic device jumps to the video clipping page, and the user may further edit the recorded video through the video clip function provided by the video clipping page, so as to obtain the recorded video that meets the user's expectation, which may improve the user's satisfaction with the generated recorded video and further improve the user's enthusiasm for sharing content.

Illustratively, the present disclosure also provides a video generation apparatus.

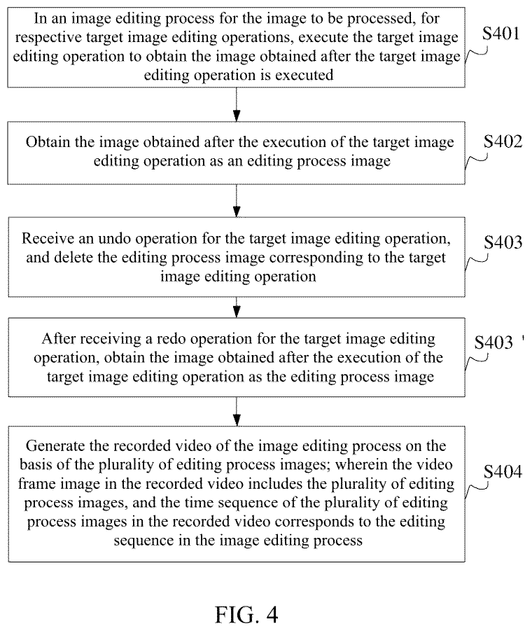

FIG. 6 is a schematic structural diagram of a video generation apparatus provided by an embodiment of the present disclosure. Referring to FIG. 6, a video generation apparatus 600 provided by this embodiment includes:
an obtaining module 601, configured to obtain a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
a processing module 602, configured to generate a recorded video of the image editing process on the basis of the plurality of editing process images; a video frame image in the recorded video includes the plurality of editing process images, and a time sequence of the plurality of editing process images in the recorded video corresponds to an editing sequence in the image editing process.

In some embodiments, the obtaining module 601 is specifically configured to obtain the image obtained after the execution of the target image editing operation as the editing process image for respective target image editing operations during the image editing process for the image to be processed.

In some embodiments, the obtaining module 601 is further configured to receive a confirmation operation for the target image editing operation before obtaining the image obtained after the target image editing operation as the editing process image; and in response to the confirmation operation, the image obtained after the execution of the target image editing operation is obtained as the editing process image.

In some embodiments, the obtaining module 601 is further configured to receive the undo operation for the target image editing operation; and in response to the undo operation, the editing process image obtained after the target image editing operation is executed is deleted.

In some embodiments, the obtaining module 601 is further configured to receive the redo operation for the target image editing operation; and in response to the redo operation, the image obtained after the execution of the target image editing operation is obtained as the editing process image.

In some embodiments, the plurality of editing process images further include the image to be processed, and the image to be processed is the first video frame image of the recorded video.

In some embodiments, the plurality of editing process images further include images obtained through the plurality of image editing operations sequentially performed on the image to be processed, and the image obtained through the plurality of image editing operations sequentially executed on the image to be processed is the last video frame image of the recorded video.

In some embodiments, the processing module 602 may also be used to edit the recorded video of the image editing process and obtain the edited recorded video.

In some embodiments, the obtaining module 601 is specifically used to store the images obtained after the execution of the different target image editing operations as editing process images in different image sets.

The video generation apparatus provided by this embodiment may be used to implement the technical scheme of any of the above-mentioned method embodiments, and its implementation principle and technical effect are similar. Please refer to the detailed description of the above-mentioned method embodiments, and for the sake of brevity, they will not be repeated here.

Illustratively, the present disclosure also provides an electronic device.

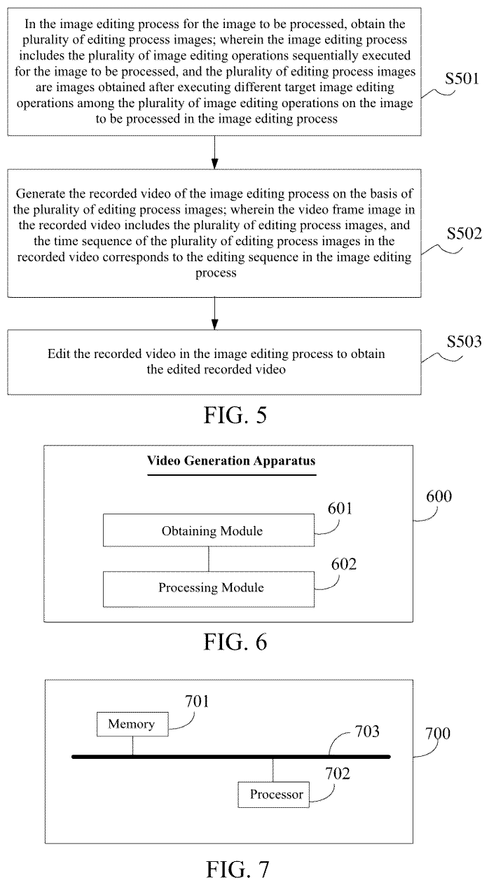

FIG. 7 is a schematic structural diagram of an electronic device provided by an embodiment of the present disclosure. Referring to FIG. 7, an electronic device 700 provided by this embodiment includes a memory 701 and a processor 702.

Herein the memory 701 may be an independent physical unit and may be connected with the processor 702 through a bus 703. The memory 701 and the processor 702 may also be integrated together and realized by hardware.

The memory 701 is used for storing program instructions, and the processor 702 calls the program instructions to execute the video generation method provided by any of the above method embodiments.

In some embodiments, when part or all of the methods in the above embodiments are implemented by software, the above electronic device 700 may only include the processor 702. The memory 701 for storing programs is located outside the electronic device 700, and the processor 702 is connected with the memory through circuits/wires for reading and executing the programs stored in the memory.

The processor 702 may be a Central Processing Unit (CPU), a Network Processor (NP) or a combination of CPU and NP.

The processor 702 may further include a hardware chip. The hardware chip may be an Application-Specific Integrated Circuit (ASIC), a Programmable Logic Device (PLD) or a combination thereof. The PLD may be a Complex Programmable Logic Device (CPLD), a Field-Programmable Gate Array (FPGA), a Generic Array Logic (GAL) or any combination thereof.

The memory 701 may include a volatile memory such as a Random-Access Memory (RAM); the memory may also include non-volatile memory, such as flash memory, Hard Disk Drive (HDD) or Solid-State Drive (SSD); the memory may also include a combination of the above kinds of memories.

The present disclosure also provides a readable storage medium, which includes computer program instructions, which, when executed by at least one processor of the electronic device, realize the video generation method provided by any of the above method embodiments.

The present disclosure also provides a computer program product, which, when executed by a computer, causes the computer to realize the video generation method provided in any method embodiment.

It should be noted that in this paper, relational terms such as “first” and “second” are only used to distinguish one entity or operation from another entity or operation, and do not necessarily require or imply that there is any such actual relationship or order between these entities or operations. Moreover, the terms “including,” “comprising” or any other variation thereof are intended to cover non-exclusive inclusion, so that a process, method, article or device including a series of elements includes not only those elements, but also other elements not explicitly listed or elements inherent to such a process, method, article or device. Without further restrictions, an element defined by the phrase “including one” does not exclude the existence of other identical elements in the process, method, article or device including the element.

What has been described above is only the specific embodiment of the present disclosure, so that those skilled in the art may understand or realize the present disclosure. Many modifications to these embodiments will be obvious to those skilled in the art, and the general principles defined herein may be implemented in other embodiments without departing from the spirit or scope of this disclosure. Therefore, this disclosure will not be limited to the embodiments described herein, but is to be accorded the widest scope consistent with the principles and novel features disclosed herein.

1. A video generation method, including:
obtaining a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
generating a recorded video of the image editing process on the basis of the plurality of editing process images; wherein a video frame image in the recorded video includes the plurality of editing process images, and a time sequence of the plurality of editing process images in the recorded video corresponds to an editing sequence in the image editing process.

2. The method according to claim 1, wherein the obtaining a plurality of editing process images in an image editing process for an image to be processed includes:
in the image editing process for the image to be processed, for respective target image editing operations, obtaining the image obtained after the target image editing operation is executed, as the editing process image.

3. The method according to claim 2, wherein before obtaining the image obtained after the target image editing operation is executed, as the editing process image, the method further includes:
receiving a confirmation operation for the target image editing operation; and
in response to the confirmation operation, obtaining the image obtained after the target image editing operation is executed, as the editing process image.

4. The method according to claim 2, wherein the method further includes:
receiving an undo operation for the target image editing operation; and
in response to the undo operation, deleting the editing process image obtained after the target image editing operation is executed.

5. The method according to claim 4, wherein the method further includes:
receiving a redo operation for the target image editing operation; and
in response to the redo operation, obtaining the image obtained after the target image editing operation is executed, as the editing process image.

6. The method according to claim 1, wherein the plurality of editing process images further include the image to be processed, and the image to be processed is a first video frame image of the recorded video.

7. The method according to claim 1, wherein the plurality of editing process images further include the image obtained through the plurality of image editing operations sequentially executed for the image to be processed, and the image obtained through the plurality of image editing operations sequentially executed for the image to be processed is a last video frame image of the recorded video.

8. The method according to claim 1, wherein the obtaining the plurality of editing process images includes:
storing the images obtained after executing the different target image editing operation as the editing process images into different image sets.

9. (canceled)

10. An electronic device, including: a memory and a processor; wherein
the memory is configured to store computer program instructions; and
the processor is configured to execute the computer program instructions, so that the electronic device realizes a video generation method including:
obtaining a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
generating a recorded video of the image editing process on the basis of the plurality of editing process images; wherein a video frame image in the recorded video includes the plurality of editing process images, and a time sequence of the plurality of editing process images in the recorded video corresponds to an editing sequence in the image editing process.

11. (canceled)

12. A computer program product which, when executed by a computer, causes the computer to realize a video generation method including:
obtaining a plurality of editing process images in an image editing process for an image to be processed; wherein the image editing process includes a plurality of image editing operations sequentially executed for the image to be processed, wherein the plurality of editing process images are images obtained after executing different target image editing operations among the plurality of image editing operations on the image to be processed in the image editing process; and
generating a recorded video of the image editing process on the basis of the plurality of editing process images; wherein a video frame image in the recorded video includes the plurality of editing process images, and a time sequence of the plurality of editing process images in the recorded video corresponds to an editing sequence in the image editing process.

13. The computer program product according to claim 12, wherein the obtaining a plurality of editing process images in an image editing process for an image to be processed includes:
in the image editing process for the image to be processed, for respective target image editing operations, obtaining the image obtained after the target image editing operation is executed, as the editing process image.

14. The computer program product according to claim 13, wherein before obtaining the image obtained after the target image editing operation is executed, as the editing process image, the method further includes:
receiving a confirmation operation for the target image editing operation; and
in response to the confirmation operation, obtaining the image obtained after the target image editing operation is executed, as the editing process image.

15. The computer program product according to claim 12, wherein the method further includes:
receiving an undo operation for the target image editing operation; and
in response to the undo operation, deleting the editing process image obtained after the target image editing operation is executed.

16. The electronic device according to claim 10, wherein the obtaining a plurality of editing process images in an image editing process for an image to be processed includes:
in the image editing process for the image to be processed, for respective target image editing operations, obtaining the image obtained after the target image editing operation is executed, as the editing process image.

17. The electronic device according to claim 16, wherein before obtaining the image obtained after the target image editing operation is executed, as the editing process image, the method further includes:
receiving a confirmation operation for the target image editing operation; and
in response to the confirmation operation, obtaining the image obtained after the target image editing operation is executed, as the editing process image.

18. The electronic device according to claim 16, wherein the method further includes:
receiving an undo operation for the target image editing operation; and
in response to the undo operation, deleting the editing process image obtained after the target image editing operation is executed.

19. The electronic device according to claim 18, wherein the method further includes:
receiving a redo operation for the target image editing operation; and
in response to the redo operation, obtaining the image obtained after the target image editing operation is executed, as the editing process image.

20. The electronic device according to claim 10, wherein the plurality of editing process images further include the image to be processed, and the image to be processed is a first video frame image of the recorded video.

21. The electronic device according to claim 10, wherein the plurality of editing process images further include the image obtained through the plurality of image editing operations sequentially executed for the image to be processed, and the image obtained through the plurality of image editing operations sequentially executed for the image to be processed is a last video frame image of the recorded video.

22. The electronic device according to claim 10, wherein the obtaining the plurality of editing process images includes:
storing the images obtained after executing the different target image editing operation as the editing process images into different image sets.
